(19) United States
(12) Patent Application Publication
(10) Pub. No.: US 2004/0060157 A1
(43) Pub. Date: Apr. 1, 2004

(54) Valve stem cap removal tool

(76) Inventor: Paul Edward Benefield, Forks of Salmon, CA (US)

Correspondence Address: Paul E. Benefield, 45200 Cecilville Rd., Forks of Salmon, Forks of Salmon, CA, 96031, US

(21) Appl. No.: 10/260,928

(22) Filed: Oct. 1, 2002

(51) Int. Cl. B23P 19/04

(52) U.S. Cl. 29/240

(57) ABSTRACT

A valve stern cap tool that is designed solely to access valve stem caps with ease from the inside wheel of dual wheeled vehicles and trailers. The tool head grips the cap firmly allowing the cap to be removed from outside the outer wheel. This tool remedies cramped and awkward access areas.

### CROSS-REERENCE TO RELATED APPLICATION

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

This tool relates to a hand tool for removal of the cap from the inside valve stem on a, dual set of tires of a vehicle or trailer.

The caps are situated between dual tires with limited access for removal. Aluminum wheels being made today have smaller openings in the wheels than steel wheels making it difficult to reach the valve stem cap with your fingers. And trying to rotate the cap is even more difficult. Reaching between the two tires is awkward and impossible for most arms if tire size or style have been changed making the opening narrower. Caps are often left off due to the difficulty of putting them back on. Dirt, water and small rocks get into the valve which affects holding proper air pressure Air pressure affects the life of the tire

### BRIEF SUJMMARY OF INVENTION

This invention is directed to a tool for removal and replacement of the valve stem cap on the inside tire of a set of dual tires. The object of this invention is to easily remove and replace the valve stem cap with hand rotations from the outside of the dual tires.

The valve stem cap remover slips firmly over the cap allowing the cap to be rotated on or off.

The hand held end of the tool is larger than the shaft making it easier to grip. It has a small compartment with a twist on lid for storage of extra caps. The shaft is narrow and able to fit through the holes of the wheel for easy access to the cap

### BRIEF DESCRIPTION OF THE SEVERAL VIEWS OF THE DRAWING

FIG. 1 is a sketch of the entire tool showing the handle, shaft, head and cap storage compartment.

The tool length is sufficient to assure that the handle is not within the confines of the wheel hole when attached.

The shaft and handle will be made of plastic or metal. The head will be made of flexible material and will grip the cap when applied.

FIG. 2 is a front view of the tool.

The head portion of the tool will be attached to the shaft and is made of flexible material for gripping the cap. The flexible opening in the head will be smaller than the cap. When the head is applied to the cap, the flexible bead holds the cap in place for rotating.

FIG. 3 is a view of the top of the tool showing the twist on lid and the cap storage compartment,

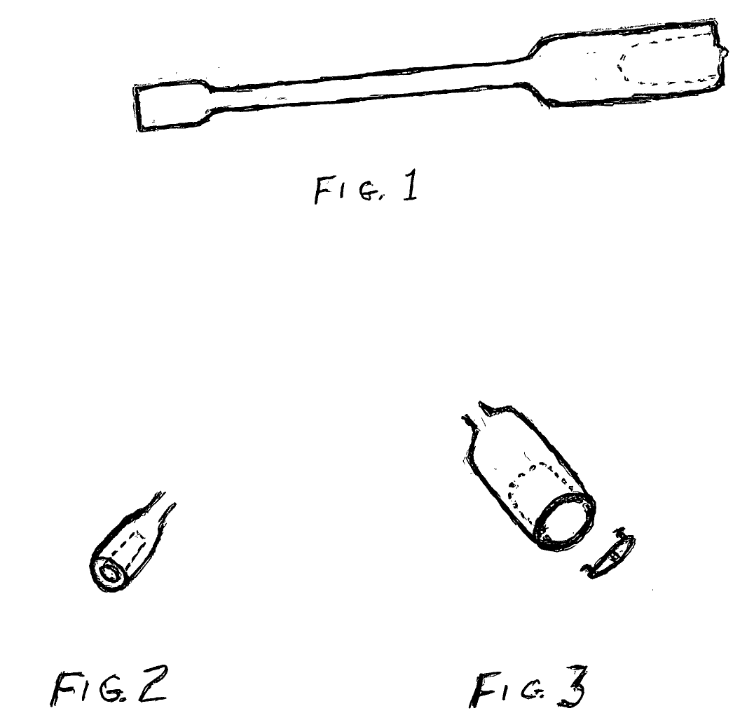

### DETALED DESCRIPTION OF THE INVENTION

This tool is a molded metal or plastic shaft and handle (similar to a screwdriver) with a flexible head at the shaft end.

Hold the handle of the tool and maneuver the flexible head of the tool through the hole of the outside wheel that lines up with the valve stem cap of the inside wheel. Press the opening of the flexible head over the valve stem. Rotate counter clockwise to remove the cap. The valve stem cap remains in the flexible head (unless manually removed) until ready to be replaced on the valve stem and rotated clockwise.

I claim:

1. A tool solely for the removal and replacement of valve stem caps on the inside wheel of dual tires of vehicles and trailers.

2. Said tool's grip tight flexible head slips over the valve stem cap securely. The valve stem cap can then be rotated off or on.

3. This tool with flexible head removes all manufactured valve stem caps.

4. The valve stem cap remains in the tool head when rotated off the valve stem. It can be retrieved manually and a new cap can be placed in the tool head for replacement on the valve stem.

5. Rotation of the valve stem cap can be easily perfumed from outside the outer wheel without obstructions.

6. This tool simplifies access to the valve stem cap on the inside wheel by extending through the hole in the outside wheel that lines up with the valve stem cap on the inside wheel.

7. The handle being longer than the shaft makes manual rotation of the tool easier outside the wheel.

8. A storage compartment for extra caps is built into the handle.

9. The tool replaces an all manually performed tediously confined task

10. Having demonstrated the structure and operation of the tool it is understood that changes in structure, material, size and shape can be made by those skilled in the art without departing from the invention.
